(19) United States
(12) Patent Application Publication
(10) Pub. No.: US 2022/0121948 A1
(43) Pub. Date: Apr. 21, 2022

(54) COMPACT SUPPORT NEURAL NETWORK

(71) Applicant: The Florida State University Research Foundation, Inc., Tallahassee, FL (US)

(72) Inventors: Adrian G. Barbu, Tallahassee, FL (US); Hongyu Mou, Tallahassee, FL (US)

(21) Appl. No.: 17/502,728

(22) Filed: Oct. 15, 2021

Related U.S. Application Data
(60) Provisional application No. 63/092,591, filed on Oct. 16, 2020.

(51) Int. Cl. G06N 3/08; G06N 3/04

(52) U.S. Cl. CPC G06N 3/082; G06N 3/04

(57) ABSTRACT

A neuron is provided that has the property of having a compact support, which means its output is zero outside a bounded domain. A method for training a neural network containing such neurons is provided, starting from a standard neural network. The approach described herein has good prediction on samples belonging to the same distribution, and it has low confidence and may return all-zero responses on data away from the training examples.

### CROSS-REFERENCE TO RELATED APPLICATIONS

This application claims the benefit of priority to U.S. Provisional Patent Application No. 63/092,591, filed on Oct. 16, 2020, entitled “COMPACT SUPPORT NEURAL NETWORK,” the contents of which are hereby incorporated by reference in its entirety.

### BACKGROUND

Neural networks (NNs) are popular and useful in many fields, but they have the problem of giving high confidence responses for examples that are away from the training data. This results in the neural network being very confident while making gross mistakes, thus limiting its reliability for safety critical applications such as autonomous driving, space exploration, etc.

The reliability of existing neural networks is conventionally improved using adversarial training, which finds examples that fool the neural network. Even using such methods, the conventional neural network intrinsically is prone to making mistakes in other regions, because the domain is unbounded and it can only be trained with limited data.

Neural networks have been proven to be extremely useful in solving all kinds of problems, including object detection, speech and handwriting recognition, medical imaging, etc. They have become the state of the art in these applications, and in some cases they even surpass human performance. However, neural networks have been observed to have a major disadvantage: they do not know when they do not know, i.e., they do not know when the input data is far away from the type of data they have been trained on. Instead of saying “I do not know”, they give some output with high confidence. This problem is very important for safety-critical applications such as space exploration, autonomous driving, and medical diagnosis. In these cases, it is important that the system know when the input data is outside the nominal parameters and alert the human (e.g., driver for autonomous driving or radiologist for medical diagnostic) to take charge.

A common way to address the problem of high confidence predictions for out-of-distribution (OOD) examples is through ensembles, where multiple neural networks are trained with different random initializations and their outputs are averaged in some way. Ensemble methods have low confidence on OOD samples because the high-confidence domain of each neural network is random outside the training data, and the common high-confidence domain is therefore shrunk by the averaging process. This reasoning works well when the representation space (the space of the neural network before the output layer) is high-dimensional, but it fails when this space is low-dimensional.

Another popular approach is adversarial training, where the training set is augmented with adversarial examples generated by maximizing the loss starting from slightly perturbed examples. This method is modified in adversarial confidence enhanced training (ACET) where the adversarial samples are added through a hybrid loss function. However, training with OOD samples is a computationally expensive if not hopeless endeavor, because the instance space is extremely vast when it is high-dimensional. Consequently, a finite number of training examples can only cover an insignificant part of it and no matter how many OOD examples are used, there always will be other parts of the instance space that have not been explored.

Other methods include the estimation of the uncertainty using dropout, softmax calibration, and the detection of out-of-distribution inputs. CutMix is a method to generate training samples with larger variability, which help improve generalization and OOD detection.

A trust score has previously been proposed that measures the agreement between a given classifier and a modified version of a k-nearest neighbor classifier. While this approach does consider the distance of the test samples to the training data, it only does so to certain extent because the k-NN does not have a concept of “too far” and is computationally expensive.

It is with respect to these and other considerations that the various aspects and embodiments of the present disclosure are presented.

### SUMMARY

Presented herein is a neuron generalization that has the standard dot-product-based neuron and the radial basis function (RBF) neuron as two extreme cases of a shape parameter. Using rectified linear unit (ReLU) as the activation function, a neuron is obtained that has compact support, which means its output is zero outside a bounded domain.

A method for training a neural network containing such neurons is provided, starting with a trained standard neural network and gradually increasing the shape parameter to a desired value. The approach described herein has good prediction accuracy on in-distribution samples (i.e., samples belonging to the same distribution), while being able to consistently detect and have low confidence on out-of-distribution samples.

In an implementation, a compact support neural network (CSNN) comprises: a first layer of neurons; a second layer of neurons, wherein the second layer comprises a plurality of compact support neurons (CSNs); and an output layer, wherein the second layer is the last layer before the output layer.

In an implementation, a method of generating a neural network comprises: obtaining a compact support neuron (CSN); obtaining a compact support neural network (CSNN) using the CSN; training the CSNN; and normalizing the CSNN.

In an implementation, a neural network environment comprises: a computing device; a compact support neuron (CSN) module configured to generate a CSN; a compact support neural network (CSNN) module configured to generate a CSNN using the CSN; a training module configured to train the CSNN; and a normalization module configured to normalize the CSNN.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for compact support neural networks (CSNNs);

FIG. 2 is an operational flow of an implementation of a method for use with CSNNs;

FIG. 3 is an illustration of a construction that smoothly interpolates between a standard neuron (α=0) and an RBF-type neuron (α=1), with neuron decision boundaries for various values of a;

FIG. 4 is a diagram of an implementation of a CSNN;

FIG. 5 shows a histogram of the norms ∥vᵢ∥ of the normalized input features vi to the compact support neuron (CSN) layer for example datasets;

FIG. 6 shows an implementation of an algorithm useful in CSNN training; and

FIG. 7 shows an exemplary computing environment in which example embodiments and aspects may be implemented.

### DETAILED DESCRIPTION

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Various inventive features are described herein that can each be used independently of one another or in combination with other features.

A neuron is provided that has compact support, which means its output is zero outside a bounded domain. A method for training a neural network with such neurons is described further herein, starting from a standard neural network.

The systems and methods described herein have good prediction on data coming from the same distribution, and give zero response to data away from the training examples. This way the network has lowest possible confidence for examples far away from the training data.

A feature described herein, as opposed to conventional neural network approaches, is that the neural network provided herein intrinsically has zero response (lowest possible confidence) far away from the training examples (i.e., in regions away from the training data, where the conventional neural networks will have high confidence but where they should be least confident). This way the neural network provided herein avoids making mistakes on such data by saying “I do not know”. The neural network described herein can still be trained with the adversarial examples, if desired.

More particularly, the contributions provided herein include the following. A type of neuron formulation that generalizes the standard neuron and the radial basis function (RBF) neuron as two extreme cases of a shape parameter. Moreover, one can smoothly transition from a regular neuron to an RBF neuron by gradually changing this parameter. The RBF correspondent to a rectified linear unit (ReLU) neuron is introduced and it is observed that it has compact support, i.e., its output is zero outside a bounded domain. Additionally, it is shown how to smoothly bend the decision boundary of a standard ReLU based neuron to obtain a compact support neuron (CSN) and how to use this construction to train a compact support neural network (CSNN) starting from a pre-trained regular neural network. The CSNN described herein achieves comparable test errors to regular CNNs (compact neural networks) and can detect and have low confidence on out-of-distribution data.

The CSNN allows for the introduction of a stricter measure of lack of confidence, which is obtained when the network returns an all-zero response. For any distribution, the percentage of the samples that have non-zero responses is a Monte Carlo estimate of the probability mass of the CSNN support under that distribution.

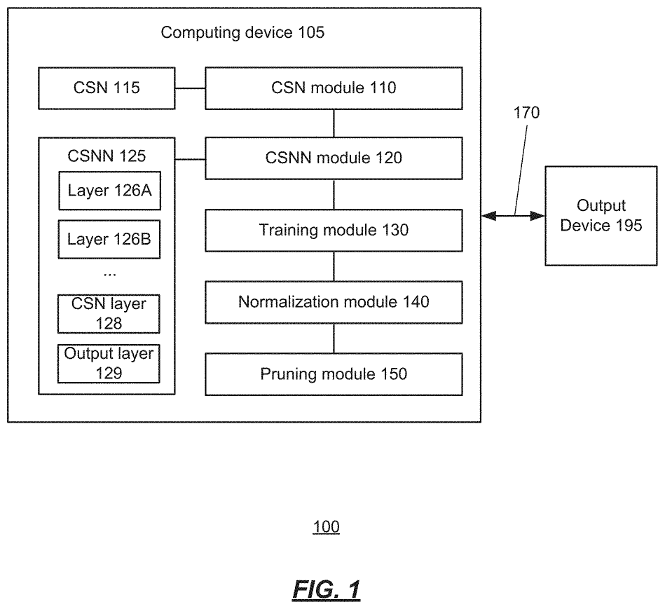

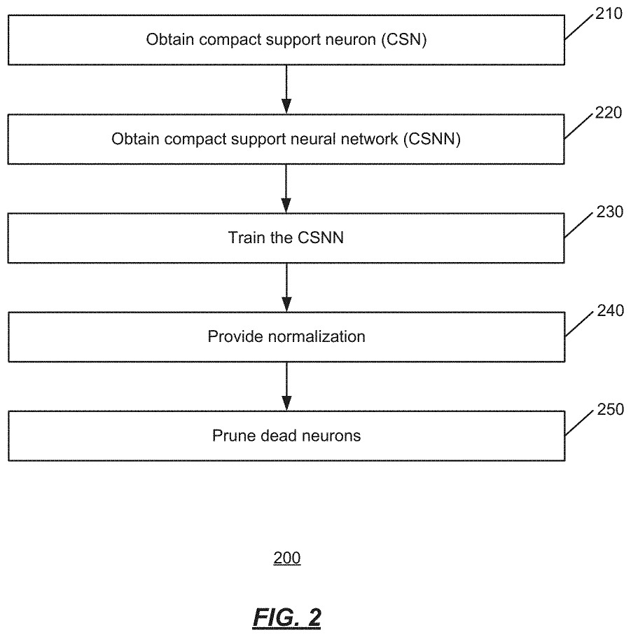

FIG. 1 is an illustration of an exemplary environment 100 for CSNNs. FIG. 2 is an operational flow of an implementation of a method 200 for use with CSNNs. The method 200 improves the reliability of neural networks in detecting objects and better characterize the conditions under which the neural network works reliably. Applications may be in, for example, autonomous driving where detecting cars, traffic lights, and pedestrians must be done reliably.

The environment 100 comprises a computing device 105. The computing device 105 may comprise a CSN module 110, a CSNN module 120, a training module 130, a normalization module 140, and a pruning module 150. The computing device 105 may be associated with, or otherwise accessible by or to, a user, such as an analyst, an administrator, etc.

The computing device 105 may provide output an output device 195, depending on the implementation. In some implementations, the output device 195 may be comprised within the computing device 105.

In some implementations, the computing device 105 (and/or the modules therein) and/or the output device 195 may be in communication through a network 170. The network 170 may be a variety of network types including the public switched telephone network (PSTN), a cellular telephone network, and a packet switched network (e.g., the Internet). Although only computing device 105 and one output device 195 are shown in FIG. 1, there is no limit to the number of computing devices 105 and output devices 195 that may be supported.

The computing device 105 and the output device 195 may be implemented using a variety of computing devices such as smartphones, desktop computers, laptop computers, tablets, set top boxes, etc. Other types of computing devices may be supported. A suitable computing device is illustrated in FIG. 7 as the computing device 700.

The CSN module 110 generates a CSN 115, at 210. The CSN 115 addresses the conventional problems and issues. The standard (conventional) neuron can be written as f(x)=σ(w^{T}x+b), which can be regarded as a projection (dot product) x→w^{T}x+b onto a direction w, followed by a nonlinearity σ(·). In such an implementation, the neuron has a large response for vectors x∈R^{p} that are in a half-space. This can be an advantage when training a neural network because it creates high connectivity in the weight space and makes the neurons sensitive to far-away signals. However, it is a disadvantage when using the trained neural network because it can lead to the neurons unpredictably firing with high responses to far-away signals, which can result (with some probability) in high confidence responses of the whole network for examples that are far away from the training data.

To address these problems, a type of radial basis function neuron f(x)=g(∥x-μ−∥²) is used and modified to have a high response only for examples that are close to μ, and has zero response at distance at least R from μ. Therefore, the neuron has compact support, and the same applies to a layer formed entirely of such neurons. Using one such compact support layer before the output layer (e.g., the CSN layer 128 and the output layer 129, respectively), it can be guaranteed that the space where the neural network has a non-zero response is bounded, obtaining a more reliable neural network.

In this formulation, the parameter vectorμ is directly comparable to the neuron inputs x, thusμ has a simple and direct interpretation as a “template”. A layer comprising such neurons forms can be interpreted as a sparse coordinate system on the manifold containing the inputs of that layer.

Because of the compact support, the loss function of such a compact support neural network has many flat areas and training it directly can be extremely difficult. However, it is described herein how to train such a neural network containing such neurons starting from a trained regular neural network and gradually bending the neuron decision boundaries to make them have smaller and smaller support.

Regarding the CSN, start with the radial basis function neuron as provided in Equation (1):

f_{w}(x)=g(∥x-w∥²) (1).

The RBF neuron has g(u)=exp(−βu) as the activation function, but herein use g(u)=max(R²-u, 0) because it is related to the ReLU.

A flexible representation is provided. Introduce an extra parameter α=1 and rewrite Equation (1) as shown in Equation (2):

f_{w}(x)=g(x^{T}x+w^{t}w−2w^{T}x)=g(α(∥x∥²+∥w∥²)−2w^{T}x) (2).

Using the parameter α, obtain a representation that smoothly changes between an RBF neuron when α=1 and a standard projection neuron when α=0. However, starting with an RBF neuron with g(u)=exp(−βu), obtain the projection neuron for α=0 as f_{w}(x)=exp(2w^{T}x), which has an exponential activation function.

More particularly, at 210, a CSN is obtained. It is desired to obtain a standard ReLU based neuron f_{w}(x)=σ(w^{T}x) with σ(u)=max(u, 0) for α=0. For this purpose, use g(u)=σ(R²−u), and modify the above construction to obtain the CSN as shown in Equation (3):

f_{w}(x)=σ(R²−x^{T}x−w^{T}w+2w^{T}x)=σ[α(R²−∥x∥²−∥w∥²−b)+2w^{T}x+b] (3)

where b is a bias term for the standard neuron. Make b=0 for simplicity. The parameter R defines the radius of the support of the neuron when α=1.

One can check that the support of f_{w}(x) from Equation (3) (i.e., the domain where it takes nonzero values) is in a sphere of radius given by Equation (4):

R_{α}²=R²+b(1/α−1)+∥w∥²(1/α²−1) (4)

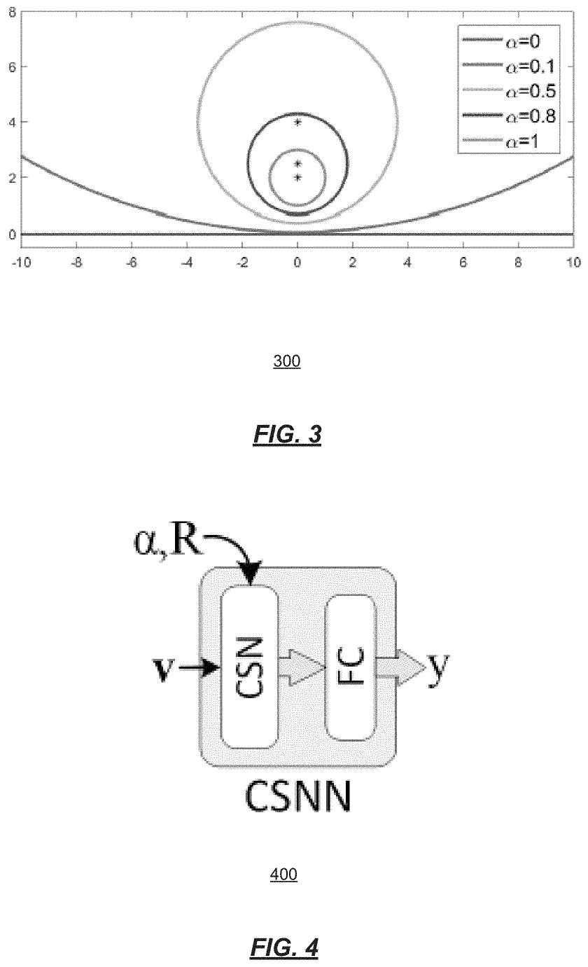

centered at w_{α}=w/α. Therefore, the neuron from Equation (3) has compact support for any α>0 and the larger the value of α, the smaller the support of the neuron will be. FIG. 3 shows the support for several values of a ∈[0, 1] of the neuron (Equation (3)) with w=(0, 2)^{T}, b=0 and R=1. FIG. 3 is an illustration 300 of a construction that smoothly interpolates between a standard neuron (α=0) and an RBF-type neuron (α=1), with neuron decision boundaries for various values of α.

A convolutional version is described. If one desires to make a compact support convolutional neuron, let w be its k×k matrix of weights. Then the convolutional version can be obtained by taking into consideration that each k×k patch of an image I is a candidate x in Equation (3). Therefore, one can check that the convolutional compact support neuron is given as in Equation (5):

f_{w}(I)=σ[α(R²−b−I²*1−∥w∥²)+2I*w+b] (5)

where 1 is a k×k matrix of ones, I² is done elementwise and * is the convolution.

The CSNN module 120 generates a CSNN 125, at 220. The CSNN 125 comprises a plurality of layers 126A, 126B, . . . , 128, 129, where the last layer 128 before the output layer 129 contains only CSNs described further herein. The other layers 126A, 126B could be regular neural network or convolutional neural network layers, or CSN layers. The output layer 129 is a regular linear layer without a bias term, so that it can output a vector of all zeros when appropriate. The output layer 129 may provide the output to the output device 195 in some implementations (e.g., via the CSNN module 120), e.g., for use in an autonomous driving application.

More particularly, at 220, a CSNN is obtained. For a layer containing only compact support neurons, combining the weights into a matrix W^{T}=(w₁, . . . , w_{K}) and the biases into a vector b=(b₁, . . . , b_{K}), write the CSN layer as given by Equation (6):

f_{W}(x)=σ(α[R²−b−x^{T}x−Tr(WW^{T})]+2Wx+b (6)

where f_{W}(x)=(f₁(x), . . . , f_{K}(x))^{T} is the vector of neuron outputs of that layer. This formulation enables the use of standard neural network machinery (e.g., PyTorch) to train a CSN. In practice, there is no bias term (i.e., b=0), except in low dimensional experiments.

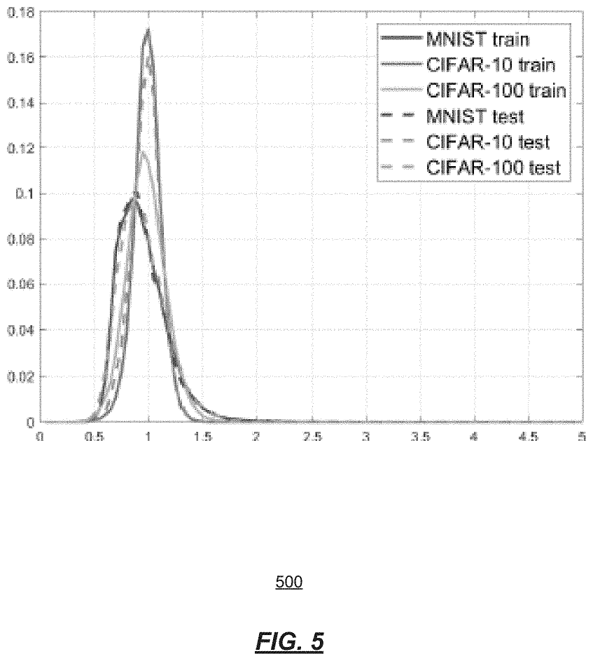

A CSNN has two layers: a hidden layer (e.g., the CSN layer 128) containing compact support neurons (Equation (3)) or their convolutional counterparts (Equation (5)), and an output layer 129 which is a standard fully connected layer without bias. This is illustrated in FIG. 4. FIG. 4 is a diagram 400 of an example CSNN 125 with the CSN layer 128 described in Equation (6).

The training module 130 may be used for training. At 230, the CSNN is trained. Like the RBF network, training a neural network with such neurons with α=1 is difficult because the loss function has many local optima. Worse, the CSNs have small support when α is close to 1, and consequently the loss function has flat regions between the local minima.

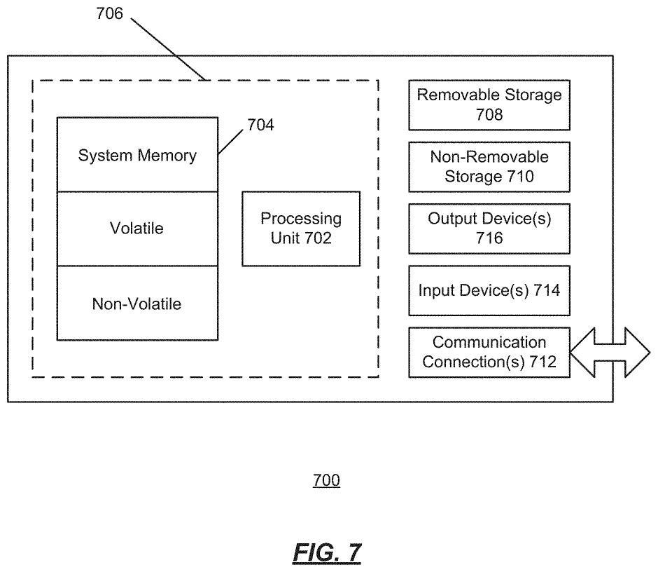

Thus, another approach to training may be implemented. Using equations (6) or (5), train a CSNN by first training a regular neural network (α=0) and then gradually increasing the shape parameter a from 0 towards 1 while continuing to update the neural network parameters. Observe that whenever α>0 the neural network has compact support, but the support gets smaller as α gets closer to 1. The training procedure is described in detail in Algorithm 1 shown in FIG. 6. FIG. 6 shows an implementation of an algorithm 600 useful in CSNN training.

In some implementations, stop the training at an α<1 where the training and validation errors still take acceptable values, e.g., a validation error less than the validation error for α=0. It has been determined that the larger the value of α, the tighter the support around the training data and the better the generalization.

It is noted that in contrast to the weights of a standard neuron, the weights of the CSN exist in the same space as the neuron inputs and they can be regarded as templates. Thus, they have more meaning, and one could easily visualize the type of responses that make them maximal, using known neuron visualization techniques. Furthermore, one can also obtain samples from the CSNs, e.g., for generative or GAN (generative adversarial network) models.

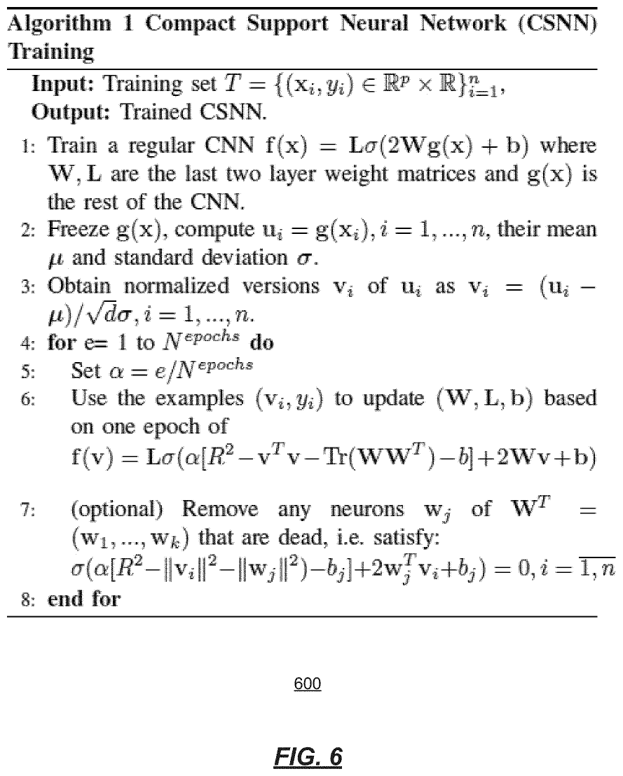

The normalization module 140 may be used for normalization. At 240, normalization is provided. For best results, all variables of the input data x should be on the same scale. For better control, it is also preferable that ∥x∥ be approximately 1 on the training examples. These goals can be achieved by standardizing the variables to have zero mean and standard deviation 1=√d on the training examples (where d is the dimension of x). This way ∥x∥²˜1 when the dimension d is large (under assumptions of normality and independence of the variables of x). It has been determined that ∥x∥˜1 on real data when the inputs x are normalized as described above, as exemplified by the histograms of ∥x∥ from FIG. 5. FIG. 5 shows a histogram 500 of the norms ∥vᵢ∥ of the normalized input features v₁to the CSN layer for three example datasets.

The pruning module 150 may be used for pruning. In some implementations, dead neurons may be pruned at 250. Due to the random initialization of the neurons, there might exist neurons that have zero response on all the training observations. These neurons are dead in the sense that they are not updated in the back-propagation because their response is always zero. It has been determined that in some cases these dead neurons will produce some small high confidence regions far away from the training examples. This problem can be eliminated by removing these neurons during training, which is done by line 7 of Algorithm 1 shown in FIG. 6.

Thus, described herein is a generic neuron formulation that encompasses the standard projection-based neuron and the RBF neuron as two extreme cases of a shape parameter α∈[0,1]. By using ReLU as the activation function, a type of neuron is obtained that has compact support. The difficulties in training the CSNN 125 may be avoided by training a standard neural network first (α=0) and gradually shrinking the support by increasing α. Advantages of the CSNN 125 are that it can still have good prediction on data coming from the same distribution, and it can detect out-of-distribution samples consistently well. This feature is important in safety critical applications such as autonomous driving, space exploration and medical imaging.

FIG. 7 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing aspects described herein includes a computing device, such as computing device 700. In its most basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This most basic configuration is illustrated in FIG. 7 by dashed line 706.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710.

Computing device 700 typically includes a variety of computer readable media. Computer readable media can be any available media that can be accessed by the device 700 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of computing device 700.

Computing device 700 may contain communication connection(s) 712 that allow the device to communicate with other devices. Computing device 700 may also have input device(s) 714 such as a keyboard, mouse, pen, voice input device, touch input device, etc. Output device(s) 716 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In an implementation, a compact support neural network (CSNN) is provided. The CSNN includes a first layer of neurons; a second layer of neurons, wherein the second layer comprises a plurality of compact support neurons (CSNs); and an output layer, wherein the second layer is the last layer before the output layer.

Implementations may include some or all of the following features. The first layer comprises a convolutional neural network layer or a CSN layer. The second layer comprises only the plurality of CSNs. Each of the CSNs has a property of compact support and provides an output of zero outside a bounded domain. The output layer provides a zero response or a lowest possible confidence in a region at or beyond a predetermined distance from training data. The output layer is a linear layer without a bias term. The output layer is configured to provide an output to an autonomous driving application. The second layer is a hidden layer containing the plurality of CSNs, and the output layer is a standard fully connected layer without bias. The second layer guarantees that a space where the CSNN has a non-zero response is bounded.

In an implementation, a method of generating a neural network is provided. The method includes obtaining a compact support neuron (CSN); obtaining a compact support neural network (CSNN) using the CSN; training the CSNN; and normalizing the CSNN.

Implementations may include some or all of the following features. The method further comprises pruning a dead neuron from the CSNN. The CSNN comprises: a first layer of neurons; a second layer of neurons, wherein the second layer comprises a plurality of CSNs; and an output layer, wherein the second layer is the last layer before the output layer. The first layer comprises a convolutional neural network layer or a CSN layer, and wherein the second layer comprises only the plurality of CSNs. Each of the CSNs has a property of compact support and provides an output of zero outside a bounded domain, and wherein the output layer provides a zero response or a lowest possible confidence in a region at or beyond a predetermined distance from training data. The output layer is a linear layer without a bias term, and wherein the output layer is configured to provide an output to an autonomous driving application. The second layer is a hidden layer containing the plurality of CSNs, wherein the second layer guarantees that a space where the CSNN has a non-zero response is bounded, and wherein the output layer is a standard fully connected layer without bias.

In an implementation, a neural network environment is provided. The environment includes a computing device; a compact support neuron (CSN) module configured to generate a CSN; a compact support neural network (CSNN) module configured to generate a CSNN using the CSN; a training module configured to train the CSNN; and a normalization module configured to normalize the CSNN.

Implementations may include some or all of the following features. The neural network environment further comprises a pruning module configured to prune a dead neuron from the CSNN. The CSNN comprises: a first layer of neurons; a second layer of neurons, wherein the second layer comprises a plurality of CSNs; and an output layer, wherein the second layer is the last layer before the output layer. Each of the CSNs has a property of compact support and provides an output of zero outside a bounded domain, and the output layer provides a zero response or a lowest possible confidence in a region at or beyond a predetermined distance from training data.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

As used herein, the singular form “a,” “an,” and “the” include plural references unless the context clearly dictates otherwise. As used herein, the terms “can,” “may,” “optionally,” “can optionally,” and “may optionally” are used interchangeably and are meant to include cases in which the condition occurs as well as cases in which the condition does not occur.

The term “comprising” and variations thereof as used herein is used synonymously with the term “including” and variations thereof and are open, non-limiting terms.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A compact support neural network (CSNN) comprising:
a first layer of neurons;
a second layer of neurons, wherein the second layer comprises a plurality of compact support neurons (CSNs); and
an output layer, wherein the second layer is the last layer before the output layer.

2. The CSNN of claim 1, wherein the first layer comprises a convolutional neural network layer or a CSN layer.

3. The CSNN of claim 1, wherein the second layer comprises only the plurality of CSNs.

4. The CSNN of claim 1, wherein each of the CSNs has a property of compact support and provides an output of zero outside a bounded domain.

5. The CSNN of claim 4, wherein the output layer provides a zero response or a lowest possible confidence in a region at or beyond a predetermined distance from training data.

6. The CSNN of claim 1, wherein the output layer is a linear layer without a bias term.

7. The CSNN of claim 1, wherein the output layer is configured to provide an output to an autonomous driving application.

8. The CSNN of claim 1, wherein the second layer is a hidden layer containing the plurality of CSNs, and the output layer is a standard fully connected layer without bias.

9. The CSNN of claim 1, wherein the second layer guarantees that a space where the CSNN has a non-zero response is bounded.

10. A method of generating a neural network, the method comprising:
obtaining a compact support neuron (CSN);
obtaining a compact support neural network (CSNN) using the CSN;
training the CSNN; and
normalizing the CSNN.

11. The method of claim 10, further comprising pruning a dead neuron from the CSNN.

12. The method of claim 10, wherein the CSNN comprises:
a first layer of neurons;
a second layer of neurons, wherein the second layer comprises a plurality of CSNs; and
an output layer, wherein the second layer is the last layer before the output layer.

13. The method of claim 12, wherein the first layer comprises a convolutional neural network layer or a CSN layer, and wherein the second layer comprises only the plurality of CSNs.

14. The method of claim 12, wherein each of the CSNs has a property of compact support and provides an output of zero outside a bounded domain, and wherein the output layer provides a zero response or a lowest possible confidence in a region at or beyond a predetermined distance from training data.

15. The method of claim 12, wherein the output layer is a linear layer without a bias term, and wherein the output layer is configured to provide an output to an autonomous driving application.

16. The method of claim 12, wherein the second layer is a hidden layer containing the plurality of CSNs, wherein the second layer guarantees that a space where the CSNN has a non-zero response is bounded, and wherein the output layer is a standard fully connected layer without bias.

17. A neural network environment comprising:
a computing device;
a compact support neuron (CSN) module configured to generate a CSN;
a compact support neural network (CSNN) module configured to generate a CSNN using the CSN;
a training module configured to train the CSNN; and
a normalization module configured to normalize the CSNN.

18. The neural network environment of claim 17, further comprising:
a pruning module configured to prune a dead neuron from the CSNN.

19. The neural network environment of claim 17, wherein the CSNN comprises:
a first layer of neurons;
a second layer of neurons, wherein the second layer comprises a plurality of CSNs; and
an output layer, wherein the second layer is the last layer before the output layer.

20. The neural network environment of claim 17, wherein each of the CSNs has a property of compact support and provides an output of zero outside a bounded domain, and wherein the output layer provides a zero response or a lowest possible confidence in a region at or beyond a predetermined distance from training data.
